(19) United States
(12) Patent Application Publication
(10) Pub. No.: US 2024/0351792 A1
(43) Pub. Date: Oct. 24, 2024

(54) MATERIAL TRANSPORT ELEVATOR

(71) Applicant: Economical Energy Pty Ltd, Adelaide (AU)

(72) Inventors: Matthew Colin FORREST, Adelaide (AU); David Alexander COUPE, Adelaide (AU)

(73) Assignee: Economical Energy Pty Ltd, Adelaide (AU)

(21) Appl. No.: 18/682,854

(22) PCT Filed: Aug. 12, 2022
(86) PCT No.: PCT/AU2022/050888

§ 371 Date: Feb. 9, 2024

(30) Foreign Application Priority Data
Aug. 12, 2021 (AU) 2021902513

(51) Int. Cl. B65G 17/12; B65G 17/36; B65G 17/40; B65G 47/44

(52) U.S. Cl. CPC B65G 17/126; B65G 17/36; B65G 17/40; B65G 47/44

(57) ABSTRACT

This disclosure relates to a material transport elevator for transporting bulk material, from a first location to a second location. In particular, the material transport elevator transports bulk material from an inlet at the first location, to an outlet at the second location via a plurality of linkage elements arranged along a length of continuous conveyor mechanism supported by and extending between the head and tail pivot points. Each linkage element comprising at least one linkage member that ensures that a center of mass of each linkage element is coincident with a line of force of the continuous conveyor mechanism.

### PRIORITY DOCUMENTS

The present application claims priority from Australian Provisional Patent Application No. 2021902513 titled “MATERIAL TRANSPORT ELEVATOR” and filed on 12 Aug. 2021, the content of which is hereby incorporated by reference in its entirety.

### TECHNICAL FIELD

The present disclosure relates to a material transport elevator. In a particular embodiment the present disclosure relates to a material transport elevator for use in transporting bulk material from one elevation to another.

### BACKGROUND

In the field of bulk material handling, there is often a need to transport bulk material over large elevations. Bucket elevators are a common solution used for conveying bulk material, particularly those bulk materials that are ‘flowable’ solid materials (e.g. grains, food products, sand, salt, gravel, mined ore etc.) often from a lower elevation to a higher elevation. Bucket elevators are conveying mechanisms that commonly comprise a continuous belt or chain with a number of buckets. These existing bucket elevators are typically loaded by passing the buckets through a first container of the bulk material located at the lower elevation, such that the buckets are filled with the bulk material by either a ‘digging’ or ‘scooping’ action. The filled buckets are then conveyed to the higher elevation and discharged in a second container by an unloading mechanism.

An example of an unloading mechanism is centrifugal discharge, whereby the filled buckets along the continuous belt or chain are emptied via centrifugal force as the buckets pass over a pulley or sprocket. The bulk material is typically discharged from the bucket being unloaded into a discharge chute that feeds the material into the second container at the higher elevation. In order for the bulk material to be fully discharged from the buckets, without any backlegging (i.e. loss of bulk material outside of the discharge chute/second container), bucket elevators with centrifugal discharge unloading mechanisms must operate the continuous belt or chain at high speeds, and pulleys or sprockets at the higher elevation typically must have a sufficiently small diameter to accommodate the centrifugal force for unloading. Additionally, it will be appreciated that bulk materials being unloaded by centrifugal discharge become projectiles (i.e. are ‘thrown’) as soon as they leave the buckets, and follow a roughly parabolic trajectory out toward the discharge chute. Accordingly, due to the higher operating speed requirement and the unloaded bulk material being projected out from the buckets, centrifugal discharge is not suitable for use with bulk materials that are fragile or at risk of damaging components of the bucket elevator.

Another example of an unloading mechanism is continuous gravity discharge. In this unloading mechanism, the buckets themselves are designed to act as part of the discharge chute to discharge the conveyed bulk material from the bucket into the second container at the higher elevation.

In both centrifugal discharge and continuous gravity discharge unloading mechanisms, the buckets are mounted to one side of the continuous belt or chain. This mounting arrangement creates a horizontal offset between the center of mass of each bucket (i.e. resultant of the bulk material filling the bucket) and the continuous belt or chain (i.e. the tensile member) to create an undesirable moment at each bucket. This is particularly undesirable for bucket elevators operating at large elevations, as an accumulated moment caused by the horizontal offset increases greatly to result in an ‘unbalanced’ conveying mechanism where a path of the continuous belt or chain deviates from being vertical. To counter this horizontal offset, and deviation from vertical, existing bucket elevators often apply pretension at a tail sprocket or include rolling elements along the length of the continuous belt or chain. Pretensioning the tail sprocket reduces the maximum load carrying capacity of the bucket elevator, and the inclusion of rolling elements increases the complexity and installation/maintenance costs of these elevators.

A further example of an unloading mechanism is positive discharge. In this unloading mechanism, the buckets are mounted such that there is a belt or chain on either side of the bucket, with a mechanism allowing the buckets to swivel in order to remain facing upright and contain the loaded bulk material. The elevator for this example further comprises a ‘tipping’ mechanism located proximal to a container to be emptied into, such that the bulk material is unloaded from the tipped bucket into the container. The use of the tipping mechanism adds complexity to this example of unloading mechanism by introducing additional moving parts that can wear, and require maintenance that is expensive and/or difficult to perform on bucket elevators operating at high elevations. This configuration makes for an inefficient use of the available transport shaft cross sectional area for several reasons. As the structural requirements of this bucket elevator belt/chain are increased with increased elevation, the belt/chain must take up a larger proportion of the transport shaft cross sectional area. Since the bucket must be able to swing freely without being able to collide with the belt/chain, there is additional shaft volume which cannot be utilised by the buckets and hence the bulk material to be conveyed. There are also imposed constraints on the shape or aspect ratio of the swinging buckets. that relate the bucket swing radius (the radius from the bucket pivot to the furthest most point of the bucket) and the radius of the transport shaft. These must be such that a bucket in any swing position or orientation cannot impact or collide with the shaft casing. This is of particular significance where the buckets enter the shaft, as a collision could cause a catastrophic failure of a bucket, casing and overall system. This constraint on aspect ratio precludes the use of long/tall buckets, which are advantageous for increasing the bucket storage volume relative to the shaft volume.

It is against this background and the problems and difficulties associated therewith, that the present invention has been developed. That is to say, there is a need for a material transport elevator capable of transporting bulk material over large elevations that addresses the problems and difficulties with existing bucket elevators and their unloading mechanisms.

### SUMMARY

Embodiments of the present disclosure relate to a material transport elevator for transporting bulk material over an elevation. The material transport elevator being intended for transporting bulk material from a head pivot point at a first location to a tail pivot point at a second location. In particular, the material transport elevator transports bulk material from an inlet proximal to the first location, to an outlet proximal to the second location via a plurality of linkage elements arranged along a length of a continuous conveyor mechanism supported by and extending between the head and tail pivot points.

Additionally, embodiments of the present disclosure relate to a linkage element for a material transport elevator. The linkage element comprising at least one linkage member that is connected to at least one carrying member, wherein bulk material is received within a payload volume of the carrying member such that, in use, a continuous conveyor mechanism comprising a plurality of the linkage elements transports bulk material from a first location to a second location wherein a center of mass of each linkage element is coincident with a line of force of the continuous conveyor mechanism.

According to a first aspect, there is provided a material transport elevator for transporting bulk material. The material transport elevator comprising: a transport means comprising at least one tail pivot point, at least one head pivot point, at least one inlet and at least one outlet, wherein the or each inlets or outlets are disposed between the or each pivot points; a continuous conveyor mechanism supported by and extending between the or each pivot points, wherein the continuous conveyor mechanism comprises a plurality of linkage elements each comprising at least one linkage member connecting the linkage elements: and wherein, in use, the linkage elements are configured to transport bulk material received at the or each inlet to the or each outlet, and the linkage members cooperate as structural load bearing members of the continuous conveyor mechanism.

In one embodiment, each of the linkage elements further comprises at least one carrying member surrounding and connected to the at least one linkage member.

In one embodiment, the at least one linkage member and each of the carrying members comprise a payload volume comprising an opening into which bulk material is received into the payload volume from the at least one inlet and through which bulk material is discharged into the at least one outlet.

In one embodiment, the or each carrying member has a cylindrical envelope or a cylindrical bounding volume that extends circumferentially around the at least one linkage member.

In one embodiment, the or each carrying member comprises a circular cross section and an axis concentric with an axis of the at least one linkage member.

In one embodiment, the at least one linkage member further comprises an inner and outer linkage means configured to connect one linkage element to another.

In one embodiment, the or each head pivot points are head sprockets and the or each tail pivot points are tail sprockets.

In one embodiment, the inner and outer linkage means each comprises one or more rollers configured to be engaged by teeth of the tail or head sprocket.

In one embodiment, teeth of the tail or head sprockets are sufficiently spaced apart to allow bulk material to be discharged from the opening of the carrying member into a discharge chute disposed between the teeth of the tail or head sprockets and subsequently into the outlet.

In one embodiment, the transport means further comprises one or more transport paths extending between the or each tail and head pivot points.

In one embodiment, the one or more transport paths comprise the at least one inlet disposed between the tail and head pivot points.

In one embodiment, the one or more transport paths each comprise a casing.

In one embodiment, the or each outlet is proximal to the or each head pivot points.

In one embodiment, bulk material from a linkage element is discharged into the at least one outlet by reorientation of the linkage element.

In one embodiment, the bulk material discharged from the reorientated linkage element is received and directed by a discharge chute to the at least one outlet.

In one embodiment, the head sprocket comprises a guide chute corresponding to a space between each of the teeth of the head sprocket.

In one embodiment, the guide chute directs bulk material discharged by the reorientated linkage element to the discharge chute in a direction of the head sprocket axis.

In one embodiment, each of the linkage elements are rigid and comprises no moving parts for when bulk material is received at the or each inlet for transport and for when the bulk material is discharged at the or each outlet.

In one embodiment, each of the linkage elements are integrally formed.

In one embodiment, the elevation at which the head sprocket is above the tail sprocket is greater than 100 meters.

In one embodiment, the tail sprocket is located at a depth below the Earth's surface.

In one embodiment, the head sprocket is located above the Earth's surface.

In one embodiment, the bulk material may comprise one or more of grain, mining ore, or other flowable solid materials.

In one embodiment, the at least one linkage member is manufactured from a composite material such as fiberglass or carbon fibre. In this embodiment, the at least one linkage member further comprises a layer of material to prevent abrasion of the composite material.

In one embodiment, a centre of mass of the bulk material is coincident with a line of force of the continuous conveyor mechanism.

According to a second aspect, there is provided a linkage element for a material transport elevator. The linkage element comprising: at least one linkage member that is connected to at least one carrying member, wherein each linkage member and each carrying member comprises a payload volume comprising an opening into which bulk material is received into the payload volume and through which the bulk material is discharged, and wherein, in use, the at least one linkage member is configured to connect linkage elements to form a continuous conveyor mechanism to transport bulk material from a first elevation to a second elevation of the material transport elevator, whereby the linkage members of the linkage elements cooperate as structural load bearing members of the continuous conveyor mechanism.

In one embodiment, the at least one linkage member is a structural load bearing member of the continuous conveyor mechanism.

In one embodiment, the or each carrying member comprises a circular cross section and an axis concentric with an axis of the linkage member.

In one embodiment, bulk material from the linkage element is discharged by reorientation of the linkage element.

According to a further aspect, there is provided a material transport elevator for transporting bulk material. The material transport elevator comprising: a transport means comprising at least one tail sprocket, at least one head sprocket at an elevation above the or each tail sprockets, one or more transport paths extending between the tail and head sprockets, wherein the one or more transport paths comprise an inlet and an outlet disposed between the tail and head sprockets, a continuous conveyor mechanism supported by and extending between the or each sprockets, wherein the continuous conveyor mechanism comprises a plurality of linkage elements each comprising at least one linkage member connecting the linkage elements and at least one carrying member connected to the at least one linkage member, wherein each of the linkage members and each of the carrying members comprise a payload volume comprising an opening into which bulk material is received into the payload volume from the inlet and through which bulk material is discharged into the outlet; and wherein, in use, the linkage elements are configured to transport bulk material received at the inlet to the outlet, and the linkage members cooperate as structural load bearing members of the continuous conveyor mechanism.

According to yet a further aspect, there is provided a material transport elevator for transporting bulk material, the material elevator comprising: a transport means comprising at least one tail pivot point, at least one head pivot point, at least one inlet and at least one outlet, wherein the or each inlets or outlets are disposed between the or each pivot points; a continuous conveyor mechanism supported by and extending between the or each pivot points, wherein the continuous conveyor mechanism comprises a plurality of linkage elements each comprising at least one carrying member and a pair of one or more linkage members on opposite sides thereof for connecting the linkage elements; wherein each linkage element is integrally formed; and wherein, in use, the linkage elements are configured to transport bulk material received at the or each inlet to the or each outlet, and the linkage members cooperate as structural load bearing members of the continuous conveyor mechanism such that a centre of mass of the bulk material is coincident with a line of force of the continuous conveyor mechanism.

### BRIEF DESCRIPTION OF THE FIGURES

Embodiments of the present disclosure will be discussed with reference to the accompanying Figures wherein:

FIG. 1 is a schematic side view of a material transport elevator for transporting bulk material;

FIG. 2 is a magnified view of a head sprocket of the material transport elevator of FIG. 1;

FIG. 3 is a top down view of a transport shaft comprising a casing and a linkage element, according to one embodiment, of a continuous conveyor mechanism of the material transport elevator;

FIG. 4 is a perspective view of a linkage element of FIG. 3;

FIG. 5 is a sectional view along line A-A of FIG. 3;

FIG. 6 is a perspective view of an embodiment of a material transport elevator comprising one or more guides corresponding to each tooth of a tail and head sprocket;

FIG. 7 is a magnified view of Detail C of FIG. 6;

FIG. 8 is a perspective view of an alternative embodiment of a material transport elevator comprising a static discharge chute centred within a head sprocket;

FIG. 9 is a magnified view of Detail D of FIG. 8;

FIG. 10 is a perspective view of a linkage element, according to an alternative embodiment;

FIG. 11 is a top down view of a transport shaft comprising a casing and the linkage element of FIG. 10;

FIG. 12 is a sectional view along line B-B of FIG. 11;

FIG. 13 is a top down view of the material transport elevator according to an embodiment;

FIG. 14 is a sectional view along line E-E of FIG. 13;

FIG. 15 is a perspective view of an alternative continuous conveyor mechanism (or alternate chain) for the material transport elevator, the alternate chain comprising a plurality of linkage elements, according to a further embodiment;

FIG. 16 is a front view of the alternate chain of FIG. 15;

FIG. 17 is a side view of the alternate chain of FIGS. 15 and 16;

FIG. 18 is a top down view of the alternate chain of FIGS. 15 to 17; and

FIG. 18 is a sectional view along line F-F of FIG. 18.

In the following description, like reference characters designate like or corresponding parts throughout the figures.

### DESCRIPTION OF EMBODIMENTS

Referring to any one of the Figures, there is disclosed a material transport elevator (100) for transporting bulk material (40) from a first location to a second location. In one example, the material transport elevator (100) transports the bulk material (40) over an elevation, that is, from a first or starting elevation to a second elevation above the first or starting elevation. The material transport elevator (100) being particularly useful when bulk material (40) is required to be transported (such as being raised or lowered) over very large elevations, for example, over elevations in excess of 100 meters. Throughout this disclosure, bulk material (40) may refer to any one or more of: grain, feedstock, fertilizers, seeds, food products, mining ore, mined rock, sand, gravel or pellets of any material. It will be appreciated by those skilled in the art that the application of the material transport elevator (100) disclosed herein, is not limited for use with only the bulk material (40) discussed above, but any flowable solid materials.

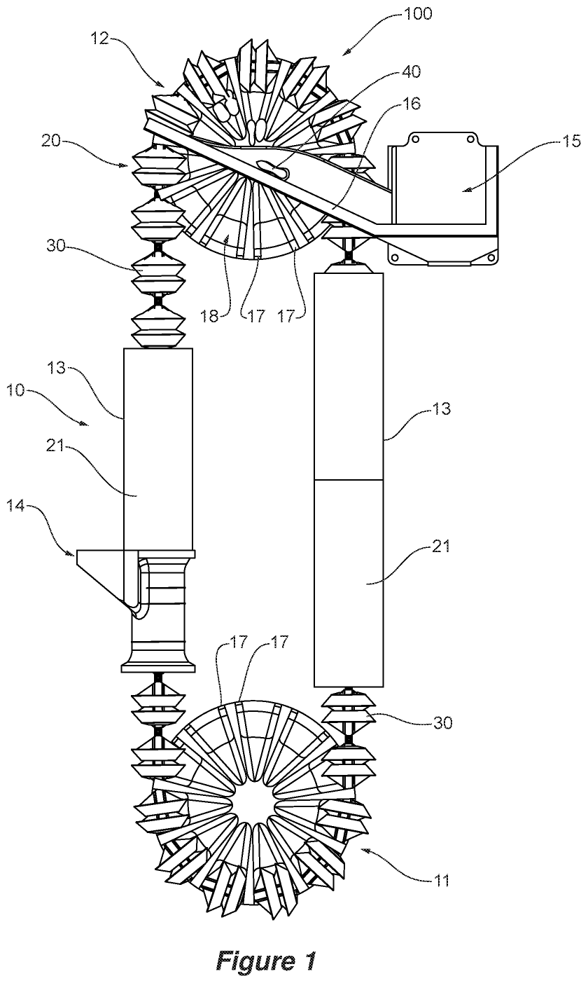

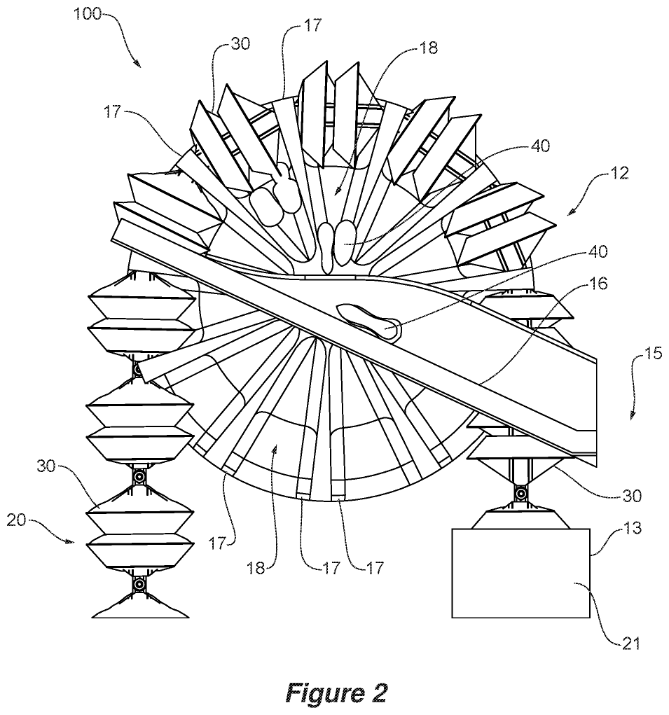

Referring particularly to FIGS. 1 and 2, there is illustrated an embodiment of the material transport elevator (100) for transporting the bulk material (40) over an elevation. In this embodiment, the material transport elevator (100) comprises: a transport means (10) comprising at least one tail pivot point (11), at least one head pivot point (12) at an elevation above the or each tail pivot points (11), at least one inlet (14) and at least one outlet (15), wherein the or each inlets (14) or outlets (15) are disposed between the or each tail (11) and head (12) pivot points. It will be understood that reference to ‘tail’ and ‘head’ pivot points may be analogous with ‘lower’ and ‘higher’ pivot points, or ‘first’ and ‘second’ pivot points or the like.

In a preferred embodiment, as illustrated in the Figures, the tail pivot point is a tail sprocket (11) and the head pivot point is a head sprocket (12). Accordingly, in the following disclosure, reference is made to tail (11) and head (12) sprockets as the preferred illustrated embodiment. It will also be understood that the sprockets or pivot points (11 and 12) may also be ‘pulleys’ or the like such that, in use, these mechanisms operate in a similar manner of the ‘sprockets’ disclosed herein.

Also in this embodiment. the material transport elevator (100) additionally comprises a continuous conveyor mechanism (20) supported by and extending between the or each of the sprockets (11 or 12). The continuous conveyor mechanism (20) may comprise a plurality of linkage elements (30) arranged along a length of the continuous conveyor mechanism (20). It will be understood that the way in which the continuous conveyor mechanism (20) is ‘continuous’, is as illustrated in the Figures, whereby the mechanism (20) extends between the tail (11) and head (12) sprockets in a continuous or endless manner (such as being illustrated in the Figures as a loop, but it will be appreciated is not limited to the single loop shape shown).

In the above embodiments, as illustrated, the material transport elevator (100) comprises sprockets (11 and 12) and the continuous conveyor mechanism (20). This illustrated embodiment may be considered a ‘chain and sprocket’ type arrangement, where the continuous conveyor mechanism (20) is equivalent to a ‘chain’. This arrangement has particular advantages when compared to ‘pulley and belt’ type arrangements utilised in existing bucket elevator systems. In these existing systems, belts engage pulleys via friction which is insufficient in its ability to reliably handle loads of a long bucket elevator column. In contradistinction, the ‘chain and sprocket’ type arrangement of the material transport elevator (100) disclosed herein utilises mechanical/geometrical grip between each sprocket (11 or 12) and the continuous conveyor mechanism (20), advantageously allowing the disclosed elevator (100) to transport larger loads and larger tension ratios between a loaded side of the elevator (100) and an unloaded side.

Further, in this embodiment with reference to any one of the Figures, the plurality of linkage elements (30) each comprise at least one linkage member (31) connecting the linkage elements (30). Wherein, in use, the plurality of linkage elements (30) are configured to transport the bulk material (40) received at the or each inlet (14) to the or each one outlet (15), and the linkage members (31) cooperate as structural load bearing members of the continuous conveyor mechanism (20). It will be understood that the structural load of the continuous conveyor mechanism (20), in use, is the bulk material (40) being transported by the loaded linkage elements (30) between the or each inlet (14) and the or each outlet (15).

By way of example, the material transport elevator (100) may be arranged as illustrated in the Figures. Whereby the outlet (15) is located proximal to the head sprocket (12) being at an elevation higher than the inlet (14), such that the plurality of linkage elements (30) are loaded with the bulk material (40) at the inlet (14) and subsequently transport the loaded bulk material (40) to the outlet (15) located at the higher elevation where the loaded bulk material (40) is discharged into the outlet (15).

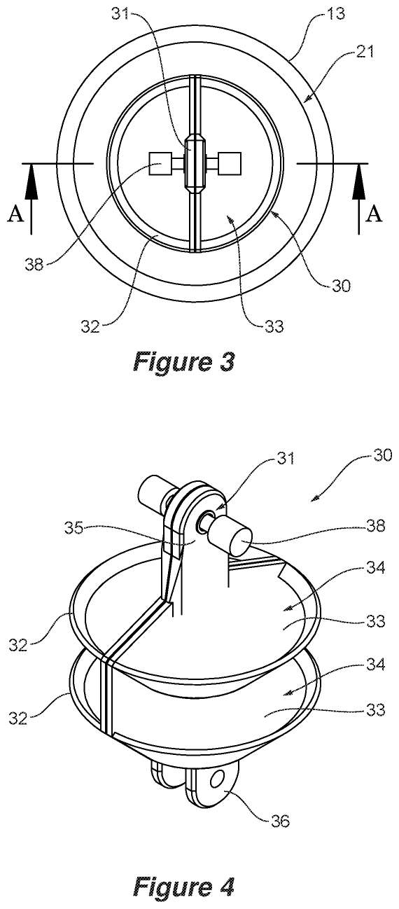

With particular reference to FIGS. 3 to 5, in one embodiment, each of the linkage elements (30) comprise at least one linkage member (31). The at least one linkage member (31) illustrated in these Figures is shown as a ‘central’ linkage member (31), however this is just one embodiment envisaged for the linkage member (31). The linkage members (31) may be considered (individually or collectively) a structural linkage member of each linkage element (30), such that when each linkage element (30) is loaded with bulk material (40) for transport, it is the linkage members (31) that bear the structural load (or act against an opposing force) imposed by the bulk material (40) being transported. In this embodiment, each of the linkage elements (30) further comprise at least one carrying member (32) that may be surrounding and connected to the at least one linkage member (31). Alternatively, the at least one carrying member (32) may simply be connected to the at least one linkage member (31). Whereby, each of the linkage members (31) and each of the load carrying members (32) comprise a payload volume (33) which comprises an opening (34) into which the bulk material (40) is received into the payload volume (33) from the at least one inlet (14) and through which the bulk material (40) is discharged into the at least one outlet (15). It will be appreciated that the payload volume (33) is particularly designed to contain the bulk material (40) for transport, and that each carrying member (32) may be considered a ‘bulk material carrying member’, ‘payload carrying member’ or the like, whereby the payload is the bulk material (40) being transported.

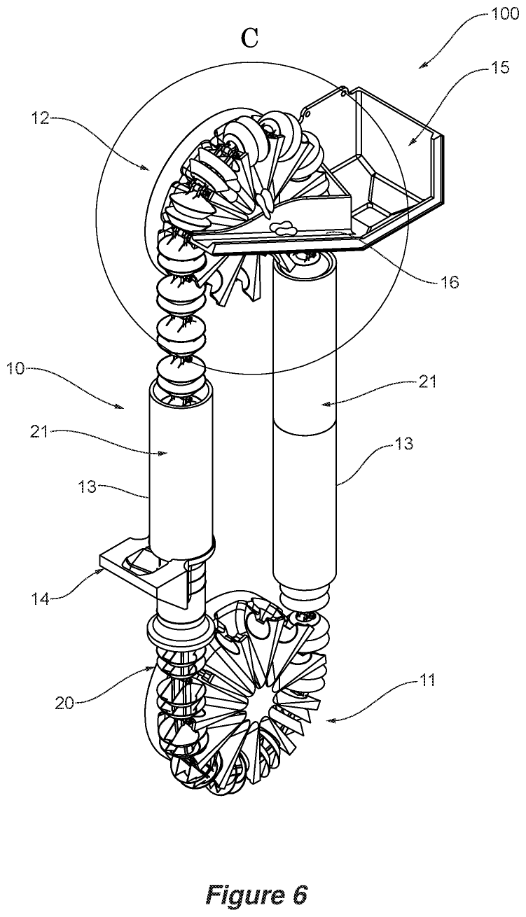

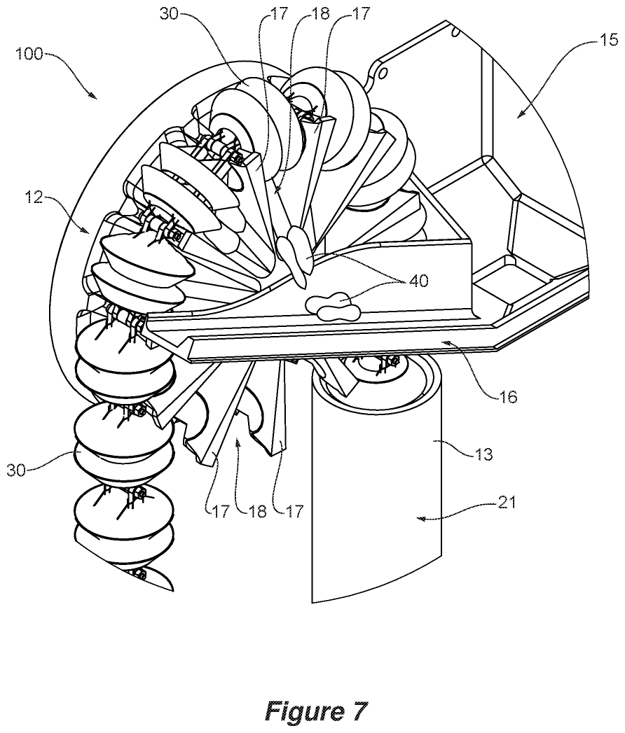

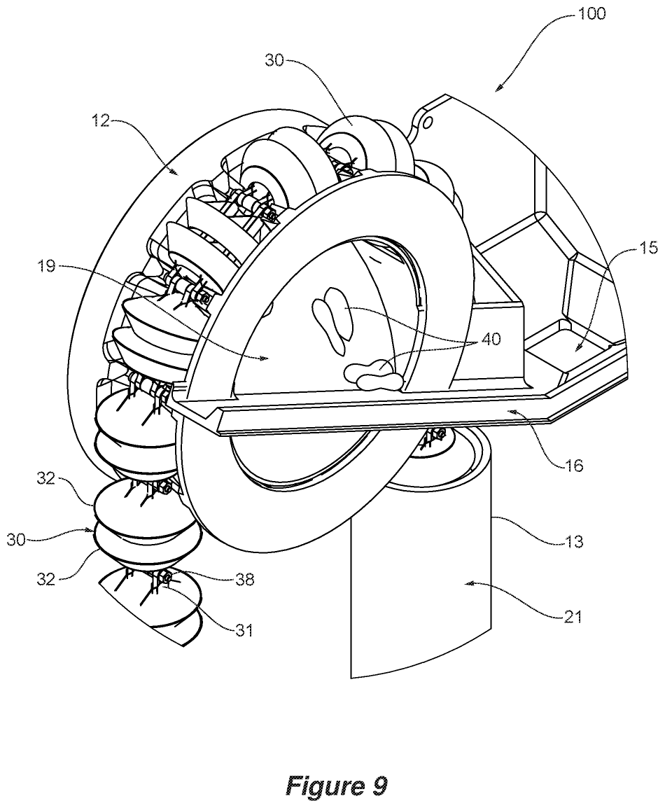

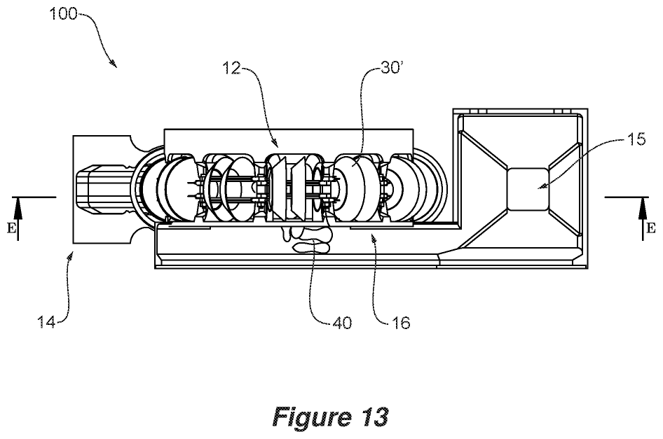

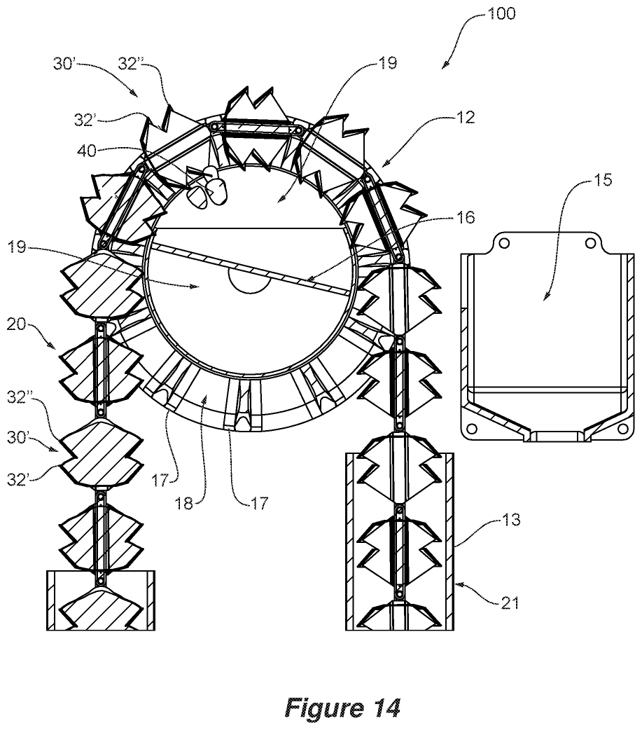

Advantageously. in one embodiment illustrated in FIGS. 1 to 14, the at least one linkage member (31) is (individually or collectively in the instance of more than one linkage member) a ‘central’ element of each of the linkage elements (30) such that the structural load of the continuous conveyor mechanism (20) passes through the centroid of each linkage element (30). Additionally, with reference to any one of the Figures and best illustrated in FIG. 4, as the at least one carrying member (32) surrounds the at least one linkage member (31), it will be understood that the structural load bearing members of the continuous conveyor mechanism (20) pass through the center of mass of each linkage element (30). That is to say, each linkage element (30) is designed such that the mass of the bulk material (40) (i.e. the pay load of bulk material being transported) is arranged around the linkage member (31), and hence the structural load bearing member of the continuous conveyor mechanism (20). In this way, it will also be understood that this arrangement of the at least one carrying member (32) surrounding the at least one linkage member (31) ensures that a center of mass of each linkage element (30) will be coincident with a line of force (or line of structural force) of the plurality of linkage elements (30) that cooperate to form the continuous conveyor mechanism (20). It will be appreciated that the line of force (or line of structural force) of the plurality of linkage elements (30) may generally be the same as a travel path of the elements (30).

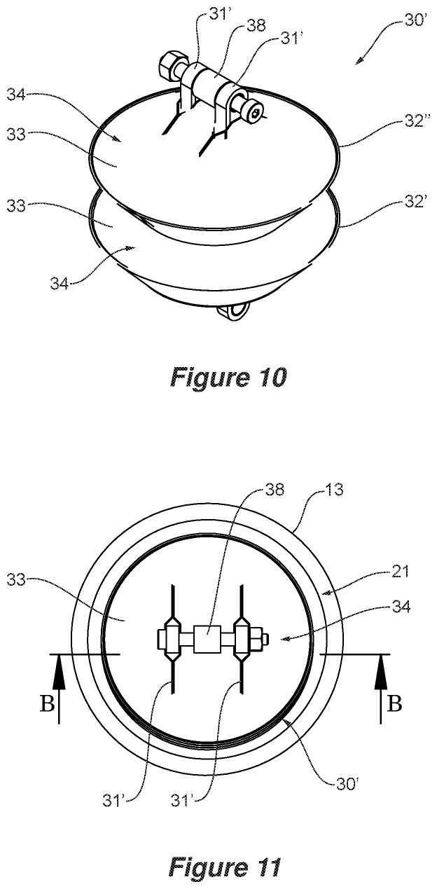

An alternative embodiment of the linkage elements (30′) is illustrated in FIGS. 10 to 12. The alternative linkage elements (30′) are illustrated with a pair of linkage members (31′), wherein the pair of linkage members (31′) collectively are considered the central structural linkage member of each alternative linkage element (30′), and cooperate so as to bear the structural load imposed by the bulk material (40) that is being transported. In this alternative embodiment, the at least one carrying member (32′) surrounds and is connected to both the pair of linkage members (31′), to thereby create the payload volume (33) which comprises the opening (34) from which the bulk material (40) is loaded and discharged. All other advantages and features of the linkage element (30) are applicable to the alternative element (30′). This alternative embodiment of the linkage element (30′) is just one alternative example envisaged by the inventors, other examples comprising more than the illustrated one or pair of linkage members are envisaged whereby in use it is these linkage members that ensure that a center of mass of each linkage element is coincident with a line of force (or line of structural force) of the plurality of linkage elements that cooperate to form the continuous conveyor mechanism (20). It will be appreciated that linkage element (30) and alternate linkage element (30′) are not limited for use in the Figures as illustrated, but may be interchanged between the two linkage elements (30 and 30′).

In any one of the above embodiments, the linkage elements (30 or 30′) of the continuous conveyor mechanism (20) are particularly designed such that they are always balanced by virtue of their center of mass being coincident with the line of force (or line of structural force), regardless of if they are loaded with the bulk material (40) fully, partially or empty.

In any one of the embodiments, as illustrated in any one of the Figures by way of example only. each linkage element (30) may comprise a pair of carrying members (32), whereby each of the carrying members (32) are surrounding and/or connected to the at least one linkage member (31), and each of the carrying members (32) comprise a payload volume (33) comprising an opening (34) into which the bulk material (40) is received into the payload volume (33) from the at least one inlet (14) and through which the bulk material (40) is discharged into the at least one outlet (15).

In one embodiment, the or each carrying member (32) has a cylindrical envelope or a cylindrical bounding volume that extends circumferentially around the at least one linkage member (31). Accordingly it will be understood that in this embodiment, the carrying member (32) (and thus the payload volume (33) defined thereby) has a circular cross section and an axis that is concentric with an axis of the at least one linkage member (31). The circular cross section of the carrying member (32) is advantageous, as it enables the continuous conveyor mechanism (20) to utilise smaller diameter pipes for transporting the bulk material (40) between the at least one inlet (14) to the at least one outlet (15). Smaller diameter shafts (for smaller diameter pipes) are cheaper to drill, are easier to install casing/lining in, and are often already drilled or are available due to prior activities on a site (e.g. from mining activities). This advantage is particularly realised in applications where the bulk material (40) is to be transported over a large elevation in excess of 100 meters. It will be appreciated that the circular cross section of each carrying member (32) is a preferred embodiment, particularly for those applications of the material transportation elevator (100) in mine sites, however other shapes for the carrying members (32) are envisaged but not disclosed herein.

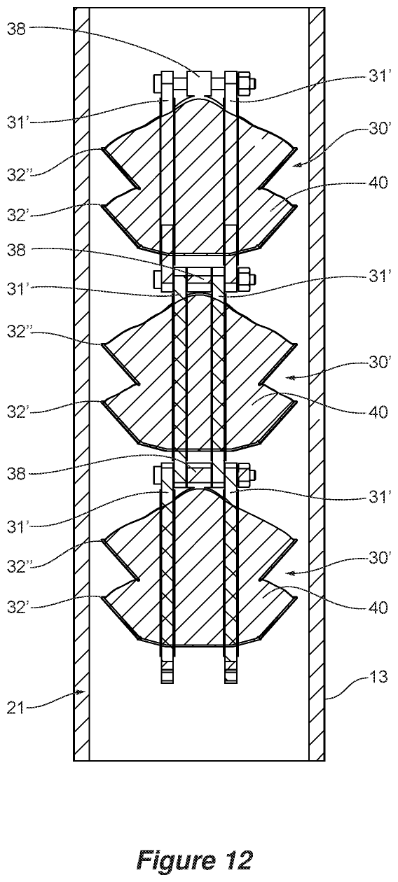

In the alternative linkage element (30′) embodiment, illustrated in FIGS. 10 to 12, the alternative linkage element (30′) is also illustrated with a pair of carrying members (32′), wherein each of the carrying members (32′) largely comprise the same characteristics and features described above. In addition to those characteristics, an upper carrying member (32″) of the pair of carrying members (32) is a cylindrical bounding volume around the pair of linkage members (31′) without a base or bottom (best illustrated by FIG. 12). A lower carrying member of the pair of carrying members (32) is also a cylindrical bounding volume around the pair of linkage members (31′) comprising a base or bottom (also illustrated in FIG. 12). In this alternative embodiment, both the upper and lower carrying members comprise the opening (34) from which the bulk material (40) is loaded and discharged, however as the upper carrying member (32″) is without a base or bottom, as bulk material (40) is loaded via its opening (34). it subsequently passes through to and fills the lower carrying member. In this way, it will be understood that the baseless or bottomless feature of the upper carrying member (32″) is another opening via which the lower carrying member can be loaded with bulk material (40). This arrangement is particularly advantageous as it ensures that both of the carrying members (32″) are sufficiently loaded with the bulk material (40) at the or each inlet (14).

A further advantage of the above baseless or bottomless alternative linkage element (30′) is that this arrangement has a higher rate at which the carrying members (32′, 32″) can be loaded or unloaded. For example, if the carrying members (32′, 32″) of the linkage elements (30′) can be loaded and unloaded 20% faster, this inherently allows the continuous conveyor mechanism (20) comprising the alternative linkage elements (30′) to achieve a 20% larger mass flow rate (of bulk material) through an otherwise identical system (100).

Now referring to FIGS. 1, 2, 4, 5, 10 and 12, in one embodiment the linkage member (31, 31′) further comprises an inner (35) and outer (36) linkage means that at are configured to connect one linkage element (30, 30′) to another to create the continuous conveyor mechanism (20). In this way, the inner (35) and outer (36) linkage means may be considered alternating connection means that are configured to facilitate the connection of one linkage element (30, 30′) to another. In this embodiment the upper (35) and lower (36) linkage means each comprise one or more rollers (38) configured to be engaged by teeth of the or each tail (11) or head (12) sprockets.

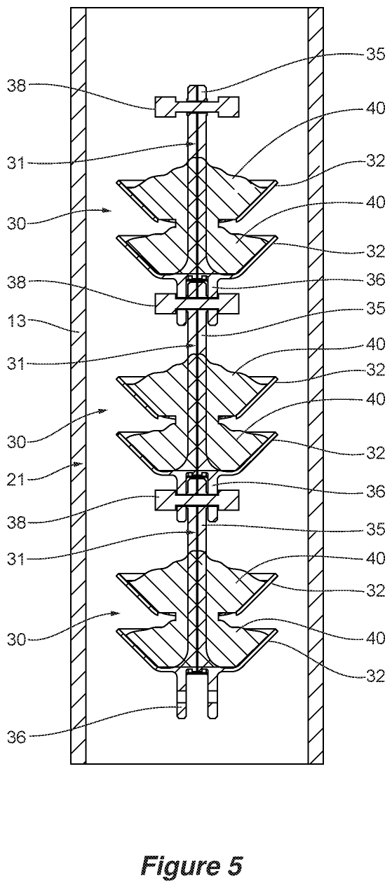

In one embodiment, best illustrated by FIGS. 4 and 5, the one or more rollers (38) are disposed on either side of the inner (35) and outer (36) linkage means. In this way, the rollers (38) assist in coupling the interaction between the sprockets (11 and 12) and the linkage elements (30) easier, as teeth of the sprockets (11 and 12) engage the rollers (38) from the sides of the linkage means (35 and 36) rather than from a center of the same. The one or more rollers (38) are retained by the inner (35) and outer (36) linkage means via a pin (may be referred to as a chain pin) that is threaded through one or more receptacles in the inner (35) and outer (36) linkage means as illustrated. Additionally, the use of one or more rollers (38) on either side of the inner (35) and outer (36) linkage means allow for shorter distance between connected linkage elements (30) within the continuous conveyor mechanism (20), in another way, the one or more rollers (38) allow for linkage means (35 and 36) of shorter length. Further, in this embodiment, placement of the one or more rollers (38) relative to the carrying member (32), and thus the payload volume (33), advantageously assist by permitting the linkage elements (30) to be filled with the bulk material (40) through a space between the linkage elements (30), that form the continuous conveyor mechanism (20), which is not occupied as a result of requirement of each linkage element (30) and the sprockets (11 or 12) to not interfere when approaching or departing from the or each sprocket (11 or 12). Accordingly, this space between the linkage elements (30) may, in use, be used for both sprocket (11 or 12) and linkage element (30) clearance as well as bulk material (40) loading and unloading, advantageously resulting in improved utilisation of the cross sectional area about the linkage member (31) of each linkage element (30).

In an alternative embodiment, best illustrated by FIGS. 10 and 12 where the alternate linkage element (30′) comprises the pair of linkage members (31′), the one or more rollers (38) is situated between the pair of linkage members (31′). It will be appreciated by those skilled in the art that this arrangement is similar to those found in typical existing power transmission chains. The alternate linkage element (30′) comprising this arrangement is particularly advantageous in those applications, i.e. those where existing power transmission chains are used, as the stress distribution is imparted onto the chain pin by the roller (38) as the roller is engaged by teeth of the sprockets (11 and 12).

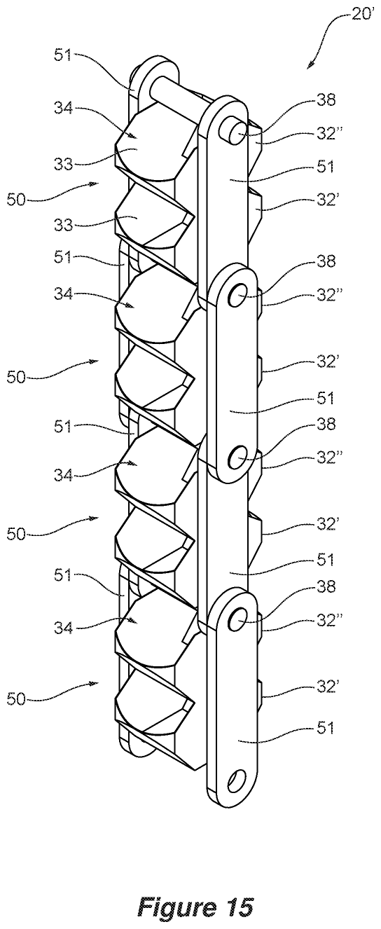

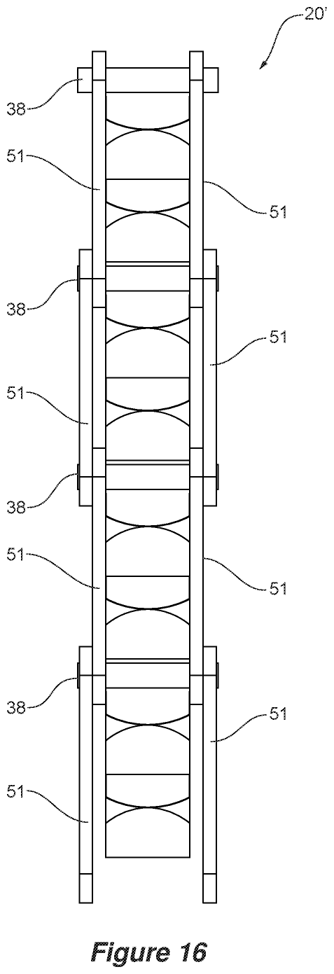

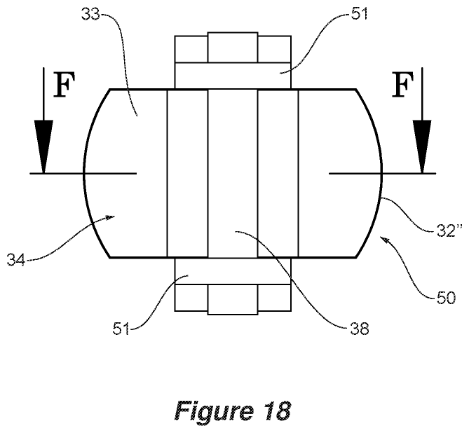

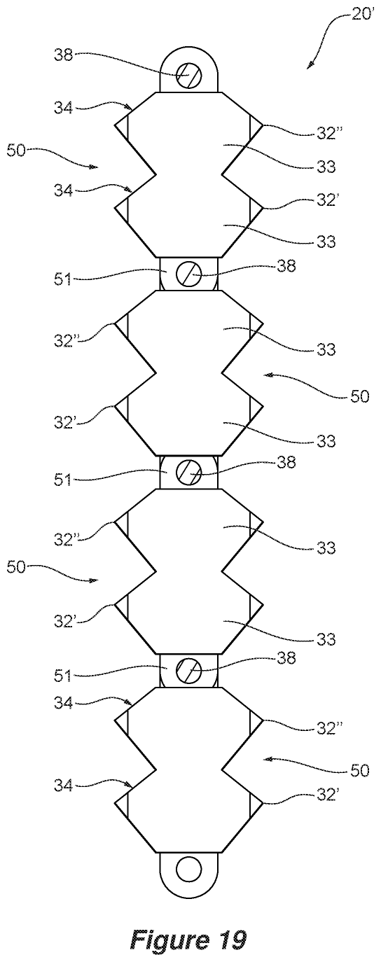

Referring now to FIGS. 15 to 18, there is illustrated an alternative embodiment of the continuous conveyor mechanism (20′) for the material transport elevator (100). In this embodiment, the alternative continuous conveyor mechanism (20′) may be considered an alternate chain (20′) for the material transport elevator (100), and those features that are similarly numbered will not be described again in detail. It will be appreciated that the alternate chain (20′) may be used in place of the continuous conveyor mechanism (20) disclosed. The alternate chain (20′) comprises a plurality of linkage elements (50), wherein these linkage elements (50) each comprise a pair of carrying members (32′ and 32″) and a pair of one or more linkage members (51) on opposing sides of the carrying members (32′ and 32″). In this illustrated alternative embodiment, the linkage members (51) are side linkage members that collectively act as the structural linkage member of each linkage element (50). Wherein, in use, when each linkage element (50) of alternate chain (20′) is loaded with bulk material (40) for transport, it is the side linkage members (51) that bear the structural load (or act against an opposing force) imposed by the bulk material (40) being transported. Additionally, when in use, the structural load of the alternate chain (20′) passes through the centroid of each linkage element (50) and a center of mass of each linkage element (50) is coincident with a line of force (or line of structural force) of the plurality of linkage elements (50) that cooperate to form the alternate chain (20′). As previously described, this line of force (or line of structural force) may generally be the same as a travel path of the elements (50). Thus these linkage elements (50) are advantageously balanced.

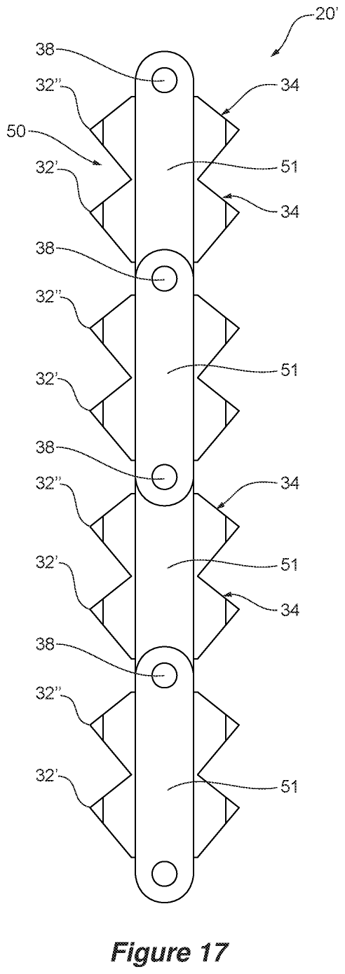

In the above embodiments, still referring to FIGS. 15 to 18, the carrying members (32′ and 32″) are positioned between the side linkage members (51). Each of the carrying members (32′ and 32″) comprise features described previously, where similar reference numbers are on the Figures. It will be appreciated that the carrying members (32′ and 32″) illustrated here are not with an exact cylindrical envelope or cylindrical bounding volume as previously described, as these carrying members (32′ and 32″) are bound on opposing sides by the linkage members (51). In this way, it will be understood that the combination of the carrying members (32′ and 32″) and the side linkage members (51) may cooperate to form the cylindrical envelope or cylindrical bounding, so as to achieve the advantages of these features as previously described. It will be appreciated that in this embodiment, that the upper carrying member (32″) does not comprise a base or bottom (best illustrated by FIGS. 17 and 19), such that as bulk material (40) is loaded via its opening (34), it subsequently passes through to and fills the lower carrying member. Although not illustrated, it is envisaged that the carrying members of these linkage elements (50) may both comprise a base or bottom.

In one embodiment, the inlet (14) may comprise a loading mechanism (not illustrated). The loading mechanism being designed so as to load one or more payload volumes (33) of one or more linkage elements (30) via respective openings (34) with the bulk material (40) to be transported to the outlet (15). It will be appreciated that the function of the loading mechanism is envisaged to load the one or more payload volumes (33) with the bulk material (40) in an efficient manner that optimises filling of the one or more payload volumes (33). An advantage of the or each carrying member (32, 32′, 32″) of each linkage element (30, 30′, 51) is that the member (32, 32′, 32″) may interact with the loading mechanism at the inlet (14) such that there is minimal contact between the bulk material (40) being loaded for transport and the inner (35) or outer (36) linkage means and the one or more rollers (38) thereof. It will be appreciated that this is desirable as it reduces the wear rate of these parts, as they are often more expensive to replace than other wearing components of the continuous conveyor mechanism (20, 20′).

In any one of the above embodiments, each of the linkage elements (30, 30′, 50) of the continuous conveyor mechanism (20, 20′) may be integrally formed. That is to say, each linkage element (30, 30′, 50) is rigid (or integral) and has no moving parts when bulk material (40) is received at the or each inlet (14) for transport and when the bulk material (40) is discharged at the or each outlet (15). It will be appreciated that by having no moving parts, the linkage elements (30, 30′, 50) are advantageously simple elements of the continuous conveyor mechanism (20, 20′) that are easy to manufacture, that do not comprise complex moving mechanisms for loading/unloading which add unnecessary sources for wear, reduce the number of parts in the mechanism (20, 20′), and allow for easy maintenance by way of simple replacement of one or more elements (30, 30′, 50) from the mechanism (20, 20′). A further advantage of the linkage elements (30, 30′, 50) being rigid (i.e. not comprising moving parts such as swinging carrying members as in existing bucket elevators), is that this reduces geometric constraints of the carrying members, which allows the material transport elevator (100) to make more efficient use of relatively smaller transport paths (13) and casings/pipes (21). One such geometric constraint for existing bucket elevator systems utilising swinging carrying members relates to the ratio of the carrying member length to the transport pipe diameter. If the length of the carrying member were twice the transport pipe diameter, then a simple malfunction of the carrying member swinging mechanism could lead to a catastrophic failure of the carrying member through collision with a transport pipe. The disclosed linkage elements (30, 30′, 50), having no moving parts, mitigates this risk of malfunction and failure, thereby allowing more efficient carrying member (32, 32′, 32″) geometry. A person skilled in the art will understand that it is only the one or more rollers (38) that are not integral with the rest of the linkage element (30, 30′ 50).

In any one of the embodiments disclosed herein, it will be understood that each of the linkage elements (30, 30′, 50) may be considered to be ‘vessels’ for transporting the bulk material (40), and that the shape of the linkage elements (30, 30′, 50) as illustrated in the Figures is not limiting, other shapes are envisaged. It will be understood that by having a circular cross section (such as an envelope or bounding volume that is more ‘plate shaped’) permits the opening (34) of the payload volume (33) to be larger/wider, such that loading and discharging of the bulk material (40) from the payload volume (33) from the or each inlet (14) or outlet (15) may be faster than an alternate vessel that has a cross section that defines a more ‘bowl shaped’ or ‘cup shaped’ envelope/proportions that has a less wide opening. That is to say, the circular cross section of the payload volume (33)/carrying member (32, 32′, 32″) comprises proportions that advantageously are capable of fully loading or completely unloading the bulk material (40) by comprising a larger/wider opening (34).

In any one of the embodiments disclosed herein, it will be understood that the continuous conveyor mechanism (20, 20′) comprises the plurality of linkage elements (30, 30′, 50) that are linked by the use of chain pins comprising one or more rollers, via the linkage elements' (30 30′, 50) respective linkage members (31, 31′, 51).

In one embodiment, the at least one linkage member (31, 31′, 51) is manufactured from a composite material such as fiberglass or carbon fibre. It will be understood that the use of modern composite materials for the structural load bearing member of the continuous conveyor mechanism (20, 20′) may advantageously contribute to application of the material transport elevator (100) to transport bulk material (40) over high elevations, as these modern composite materials comprise high strength to weight ratios and have higher allowable tensile stresses. In this embodiment, the composite linkage member (31, 31′, 51) may additionally comprise a protective layer to shield the linkage member (31, 31″, 51) from abrasion during loading, transport and discharge of the bulk material (40). Alternative manufacturing materials are also envisaged beyond those disclosed. Materials for manufacture may be selected such that strength to weight ratios and tensile stresses of the linkage member (31, 31′, 51) is maximised.

Although not the subject of this application, as the disclosed linkage elements (30, 30′, 50) may be integrally formed, the elements (30, 30′, 50) and/or the linkage members (31, 31′, 51) may advantageously be manufactured via known and future methods that are easy to automate. The manufacturing method(s) will preferably utilise composite materials in a manner that maximises the resultant elements (30, 30′, 50) and/or linkage members (31, 31′, 51) strength to weight ratio, and aim to optimise the composite materials ability to perform at higher tensile stresses.

In one embodiment, the transport means (10) further comprises one or more transport paths (13) extending between the or each tail (11) and head (12) sprockets. In this embodiment, the one or more transport paths may comprise the at least one inlet (14) disposed between the tail (11) and head (12) sprockets. The transport paths (13), if the material transport elevator (100) is utilised in an underground (e.g. mining) site, may be transport shafts and in other ‘above ground’ sites the transport path (13) may be transport pipes. In any one of these examples, the transport paths (13) may comprise a casing (21), the casing (21) may comprise piping or tubing with an internal diameter capable of housing the continuous conveyor mechanism (20, 20′) that extends through the one or more transport paths (13) and between the tail (11) and head (12) sprockets. In this way, the casing (21) accommodates the continuous conveyor mechanism (20, 20′) and the plurality of linkage elements (30, 30′, 50), advantageously protecting them from external elements or geological features. It will be appreciated for subterranean applications of the material transport elevator (100), that the casing (21) may be cemented in place by known methods for securing and structurally supporting casing/piping/tubing in subterranean settings. In the illustrated embodiments of the material transport elevator (100), there is a pair of casings (21) corresponding to transport paths (13) to accommodate the continuous conveyor mechanism (20, 20′) on either side of the or each tail (11) or head (12) sprockets.

In any one of the above embodiments. as best illustrated in FIGS. 1, 2, 6 to 9, 13 and 14, bulk material (40) from a linkage element (30, 30′, 50) is discharged into the at least one outlet (15) by reorientation of the linkage element (30, 30′, 50). That is to say, bulk material (40) contained in the payload volume (33) of the carrying member (32, 32′, 32″) is discharged (or emptied, or unloaded) by the reorientation of the linkage element (30, 30′, 50) as it is transported around the at least one head sprocket (12) and into the at least one outlet (15) proximal to said head sprocket (12).

In one embodiment, the bulk material (40) discharged from the reorientated linkage element (30, 30′, 50) is received and directed by a discharge chute (16) to the at least one outlet (15). As illustrated in the Figures, the discharge chute (16) may be positioned such that it is able to receive the discharged bulk material (40) from the linkage elements (30, 30′, 50) reorientated at the at least one head sprocket (12), and so that the discharge chute (16) spans a length to direct the discharged bulk material (40) to the at least one outlet (15) located proximal to the head sprocket (12).

In one embodiment, referring to FIGS. 1, 2, 6 and 7, the teeth of the or each tail (11) or head (12) sprockets are sufficiently spaced apart to allow bulk material (40) to be discharged from the opening (34) of the carrying member (32, 32′, 32″) into the discharge chute (16). In this embodiment, the discharge chute (16) is disposed between the teeth of the or each tail (11) or head (12) sprockets where the linkage elements (30, 30′, 50) are being reorientated, and the at least one outlet (15). The teeth of the or each tail (11) or head (12) sprockets may be considered continuous conveyor mechanism (20, 20′) engaging teeth (or chain-engaging teeth), and the spacing between the teeth is such that bulk material (40) discharged from a reorientated linkage element (30, 30′, 50) flows radially inwards or downwards toward the discharge chute (16) where the discharged bulk material (40) is received.

In the above embodiment, the or each tail (11) or head (12) sprockets may comprise one or more guide chutes (18), where each guide chute (18) corresponds to a space between each of the teeth of the sprockets (11) or (12). Referring particularly to FIGS. 2 and 7, there is illustrated in detail the head sprocket (12) comprising guide chutes (18) in the space between each of the teeth of the sprocket (12). In these Figures, it is illustrated that each of the guide chutes (18) directs bulk material (40) being discharged from the opening (34) of the reorientated linkage element (30, 30′, 50) to the discharge chute (16) in a direction of the head sprocket (12) axis. It will be appreciated that the guide chutes (18) advantageously assist in retention of discharged bulk material (40), by ensuring that the discharged material (40) is correctly directed to the discharge chute (16) and ultimately the at least one outlet (15), the intended destination for the transported bulk material (40). It will also be appreciated that the guide chutes (18) may be considered a plurality of ‘individual chutes’ that reside in the space between the teeth of the tail (11) or head (12) sprockets.

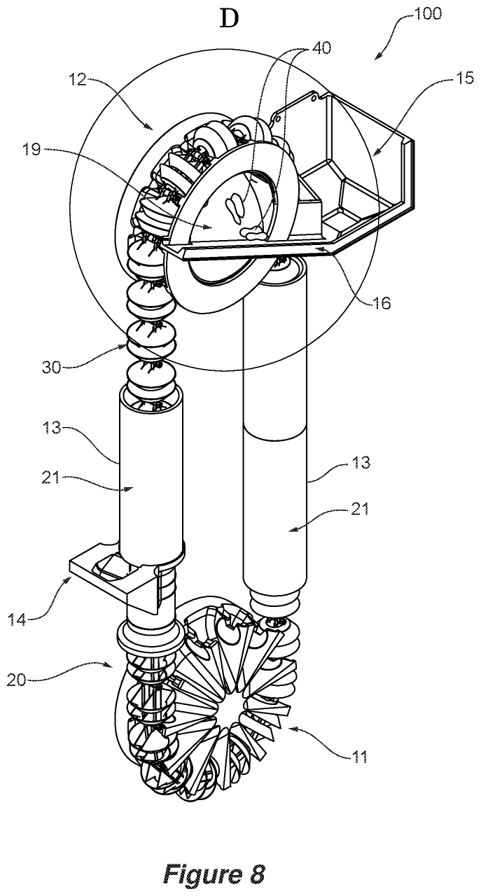

In an alternative embodiment, referring now to the material transport elevator (100) illustrated in FIGS. 8, 9, 13 and 14, the at least one head sprocket (12) may comprise a static discharge chute (19) disposed within a hollow center of the head sprocket (12) and between a point where the linkage elements (30, 30′, 50) are reorientated for discharging bulk material (40) and the discharge chute (16). The static discharge chute (19) may alternatively be considered a guide chute (19), wherein the guide chute (19) is centrally disposed within the hollow center of the head sprocket (12). In this alternate embodiment, the static discharge chute (19) directs bulk material (40) being discharged from the opening (34) of the reorientated linkage element (30, 30′, 50) to the discharge chute (16) in a direction of the head sprocket (12) axis. It will be understood that the static discharge chute (19) may be considered a single stationary chute in place of the one or more guide chutes (18) of the previous embodiment, whereby the static discharge chute (19) is fixed within the hollow center of the head sprocket (12), and does not reorientate or rotate with the sprocket (12) as the continuous conveyor mechanism (20, 20′) transports bulk material (40).

In any one of the above embodiments, the present material transport elevator (100) when compared to existing centrifugal discharge bucket elevators is more gentle on both the bulk material (40) being transported and the components of the continuous conveyor mechanism (20, 20′), especially over large elevations. This is particularly due to the disclosed material transport elevator (100) being able to operate at lower velocities to discharge bulk material (40) when discharging by reorientating the linkage elements (30, 30′, 50). Lower velocity operations are possible due to the structural configuration of the linkage elements (30, 30′, 50), and the way in which they are simply reorientated to completely discharge/empty/unload contained bulk material (40) therefrom. The combination of linkage element (30, 30′, 50) design, reorientation thereof for discharge, and location of the discharge chute (16), allows for the discharged bulk material (40) to travel inwards/downwards in a direction of the sprocket (11 or 12) axis. In contradistinction, in existing centrifugal discharge systems, bulk materials being unloaded follow a roughly parabolic trajectory effectively ‘thrown’ from the buckets being emptied at high velocities to ensure complete emptying of said buckets. Thus, the material transport elevator (100) being advantageously able to operate at lower velocities, enables the present disclosure to be utilised in applications where the bulk material (40) being transported is fragile or at risk of damaging components of the material transport elevator (100). Furthermore, the ability to operate at lower velocities reduces the rate of wear on all components of the material transport elevator (100) that the bulk material (40) being transported comes into contact with. Finally, it will be understood that the present material elevator (100) can operate at a variety of operation speeds when in use transporting bulk material (40) from a lower elevation to a higher elevation, when compared to existing centrifugal discharge systems which are limited to operating at higher velocities only.

In any one of the above embodiments, it will be appreciated that an advantage of the reorientation of the linkage elements (30, 30′, 50) for discharging/emptying/unloading of the contained bulk material (40), is that there is no requirement for any additional ‘tripping/tipping mechanisms’ to empty loaded linkage elements (30, 30′, 50), such as those required for existing positive discharge systems. This advantage is further realised by way of the material transport elevator (100) having reduced complexity when compared to those existing systems, and realised more so when applying the material transport elevator (100) to large elevations in excess of 100 meters, which inherently will already have a high part count and each additional moving part is an additional source of wear and maintenance. It will also be understood that in the material transport elevator (100) disclosed, there is no need for anything to ‘actuate’ or ‘operate’ in order for the discharging/emptying/unloading of the bulk material (40) at the head sprocket (12) and into the outlet (15) from the linkage element (30, 30′, 50) to occur.

In any one of the above embodiments comprising the discharge chute (16), it will be appreciated that the discharge chute (16) may advantageously be located higher relative to the head sprocket (12), thus resulting in a more compact structure about the head sprocket (12) for discharging bulk material (40), when compared to existing centrifugal discharge systems.

In any one of the above embodiments, the tail sprocket (11) may be located at a depth below the Earth's surface, and the head sprocket (12) is located at a depth above the tail sprocket (11) which may still be below the Earth's surface, or above the Earth's surface. It will be understood that this arrangement will be viable when transporting bulk material (40), such as pelletised mine tailings or mining ore, from a location below the Earth's surface to above the Earth's surface.

In any one of the above embodiments, the sprockets (11, 12) may be other mechanisms such as ‘pulleys’ or the like that allow the material transport elevator (100) to achieve its function of transporting bulk material (40) from one elevation/location to another. That is to say, other mechanisms (such as ‘pulleys’ or the like) are envisaged to in place of the sprockets (11,12) that engage, direct and redirect the continuous conveyor mechanism (20, 20′) and transport, load and empty the plurality of linkage elements (30, 30′, 50).

In any one of the above embodiments, it will be understood that one of the advantages of the disclosed material transport elevator (100) is that the at least one linkage member (31), the pair of linkage members (31′), or the side linkage members (51), cooperate to be the integral structural element of each of the linkage elements (30, 30′, 50), such that the structural load of the continuous conveyor mechanism (20, 20′) passes through the centroid of each linkage element (30, 30′, 50). This arrangement of the present disclosure has advantages in that the linkage members (31, 31′, 51) cooperate to act as the structural load bearing members of the continuous conveyor mechanism (20, 20′), such that the centre of mass of the bulk material (40) is coincident with the line of force (or line of structural force) of the continuous conveyor mechanism (20, 20′) between the inlet (14) to the outlet (15). Resultantly, there is no moment created by the linkage elements (30, 30′, 50) to deviate the continuous conveyor mechanism (20, 20′) from its vertical centerline. Accordingly, the material transport elevator (100) disclosed herein will advantageously be understood to be ‘balanced’ (i.e. the bulk material being transported is balanced about the linkage member of each linkage element and thus the continuous conveyor mechanism which they form when in connection) without the use of complex componentry or an excess number of components. This advantage is particularly realised when using the disclosed material transport elevator (100) in transporting bulk material (40) over large elevations greater than 100 meters.

A further advantage of the material transport elevator (100) is that by comprising features that prevent the continuous conveyor mechanism (20, 20′) from deviating from its vertical centerline, the continuous conveyor mechanism (20, 20′) does not require pretension at any of the sprockets (11 or 12) or rolling supports along its length (as is required by existing bucket elevators employing either one of centrifugal discharge or continuous gravity discharge unloading mechanisms). As the disclosed elevator (100) does not require pretensioning at the sprockets (11 or 12), the elevator (100) has an increased load carrying capacity at greater operable heights when compared to existing bucket elevator systems.

It will be understood that the material transport elevator (100) disclosed herein has particular advantages when applied to mining operations. The circular cross section of the carrying member (32, 32′, 32′′), and thus the overall linkage elements (30, 30′, 50), is generally small in cross section and is able to operate at high mass flow rates (i.e. bulk material transportation rates). Small cross sections are advantageous in mining operations as it allows the transport paths (13) (in this mining examples transport shafts), corresponding casing (21) and lengths of the continuous conveyor mechanism (20, 20′) to travel therethrough to be installed in small hoisting elevator shafts, or in cheaply drilled bore holes.

It will also be understood, in an embodiment not illustrated, that the material transport elevator (100) disclosed herein may be applied over versatile paths for transporting bulk material (40) from a lower elevation to a higher elevation. That is to say, a path of the transport means (10) and that travelled by the continuous conveyor mechanism (20, 20′) may be reoriented by the use of multiple sprockets (not illustrated) disposed between the tail (11) and head (12) sprockets (i.e. external or internal to the loop created by the tail and head sprockets illustrated in the Figures). This is particularly advantageous and allows the material transport elevator to operate in a bidirectional operation, as well as for conveniently locating additional sprockets that may be utilised for taking up slack of the continuous conveyor mechanism (20, 20′) at points between the tail (11) and head (12) sprockets.

A further advantage of the material transport elevator (100) disclosed herein is that it may be utilised in existing gravitational potential energy storage systems such as the subterranean energy storage system disclosed in PCT/AU2020/000129. Gravitational potential energy storage systems may benefit from the flexibility of the material transport elevator (100), in that it can operate at varying transport velocities/mass flow rates, it can be applied over large elevations, it comprises minimal componentry (especially when considering unloading) so as to minimise wear and maintenance, it is a balanced system whereby the centre of mass of the bulk material being transported is coincident with the travel path (or line of action) of the continuous conveyor mechanism, and that it comprises a central tensile member (or tensile group member, as the at least one linkage member) that passes through the transported material volume between an inlet to an outlet (and vice-versa) to store and release potential energy allowing for improved density and reduced transportation shaft diameter to accommodate the continuous conveyor mechanism.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A material transport elevator for transporting bulk material, the material elevator comprising: a transport means comprising at least one tail sprocket, at least one head sprocket, at least one inlet and at least one outlet, wherein the or each inlets or outlets are disposed between the or each sprockets;
a continuous conveyor mechanism supported by and extending between the or each sprockets, wherein the continuous conveyor mechanism comprises a plurality of linkage elements each comprising at least one linkage member connecting the linkage elements; and
wherein, in use, the linkage elements are configured to transport bulk material received at the or each inlet to be discharged into a guide chute corresponding to a space between teeth of the tail or head sprockets and subsequently into the or each outlet, and the linkage members cooperate as structural load bearing members of the continuous conveyor mechanism.

2. The material transport elevator of claim 1, wherein each of the linkage elements further comprises at least one carrying member surrounding and connected to the at least one linkage member.

3. The material transport elevator of claim 2, wherein the at least one linkage member and each of the carrying members comprise a payload volume comprising an opening into which bulk material is received into the payload volume from the at least one inlet and through which bulk material is discharged into the at least one outlet.

4. The material transport elevator of claim 2, wherein the or each carrying member has a cylindrical envelope or a cylindrical bounding volume that extends circumferentially around the at least one linkage member.

5. The material transport elevator of claim 2, wherein the or each carrying member comprises a circular cross section and an axis concentric with an axis of the at least one linkage member.

6. The material transport elevator of claim 1, wherein the at least one linkage member further comprises an inner and outer linkage means configured to connect one linkage element to another.

7. The material transport elevator of claim 6, wherein the inner and outer linkage means each comprises one or more rollers configured to be engaged by teeth of the tail or head sprocket.

8. The material transport elevator as in claim 3, wherein the teeth of the tail or head sprockets are sufficiently spaced apart to allow bulk material to be discharged from the opening of the carrying member into a discharge chute and subsequently into the outlet.

9. The material transport elevator of claim 1, wherein the transport means further comprises one or more transport paths extending between the or each tail and head sprockets.

10. The material transport elevator of claim 9, wherein the one or more transport paths comprise the at least one inlet disposed between the tail and head sprockets.

11. The material transport elevator of claim 1, wherein the or each outlet is proximal to the or each head sprockets.

12. The material transport elevator of claim 1, wherein bulk material from a linkage element is discharged into the at least one outlet by reorientation of the linkage element.

13. The material transport elevator of claim 12, wherein the bulk material discharged from the reorientated linkage element is received and directed by a discharge chute to the at least one outlet.

14. The material transport elevator of claim 13, wherein the guide chute directs bulk material discharged by the reorientated linkage element to the discharge chute in a direction of the head sprocket axis.

15. The material transport elevator of claim 12, wherein the head sprocket comprises a static discharge chute to direct bulk material discharged by a reorientated linkage element to the discharge chute.

16. The material transport elevator of claim 1, wherein each of the linkage elements is rigid and comprises no moving parts for when bulk material is received at the or each inlet for transport, and for when the bulk material is discharged at the or each outlet.

17. The material transport elevator of claim 1, wherein a center of mass of the bulk material is coincident with a resultant line of force of the continuous conveyor mechanism.

18. A linkage element for a material transport elevator, the linkage element comprising:
at least one linkage member that is connected to at least one carrying member, wherein each linkage member and each carrying member comprises a payload volume comprising an opening into which bulk material is received into the payload volume and through which the bulk material is discharged; and wherein, in use, the at least one linkage member is configured to connect linkage elements to form a continuous conveyor mechanism to transport bulk material from a first elevation to a second elevation of the material transport elevator, whereby the linkage members of the linkage elements cooperate as structural load bearing members of the continuous conveyor mechanism such that a center of mass of the linkage element is coincident with a resultant line of force of the continuous conveyor mechanism regardless of if the carrying member is empty, or loaded either partially or fully with bulk material.

19. The linkage element of claim 18, wherein the at least one linkage member is a structural load bearing member of the continuous conveyor mechanism.

20. The linkage element of claim 18, wherein bulk material from the linkage element is discharged by reorientation of the linkage element.

21. The linkage element of claim 18, wherein the linkage element is integrally formed.

22. A material transport elevator for transporting bulk material, the material elevator comprising:
a transport means comprising at least one tail sprocket, at least one head sprocket at an elevation above the or each tail sprockets, one or more transport paths extending between the tail and head sprockets, wherein the one or more transport paths comprise an inlet and an outlet disposed between the tail and head sprockets;
a continuous conveyor mechanism supported by and extending between the or each sprockets, wherein the continuous conveyor mechanism comprises a plurality of linkage elements each comprising at least one carrying member and at least one linkage member on opposing sides thereof for connecting the linkage elements, wherein each of the carrying members comprise a payload volume comprising an opening into which bulk material is received from the inlet and through which bulk material is discharged into the outlet;
wherein each linkage element is integrally formed; and
wherein, in use, the linkage elements are configured to transport bulk material received at the inlet to the outlet, and the linkage members cooperate as structural load bearing members of the continuous conveyor mechanism such that a center of mass of the bulk material is coincident with a resultant line of force of the continuous conveyor mechanism.

23. A material transport elevator for transporting bulk material, the material elevator comprising:
a transport means comprising at least one tail pivot point, at least one head pivot point, at least one inlet and at least one outlet, wherein the or each inlets or outlets are disposed between the or each pivot points;
a continuous conveyor mechanism supported by and extending between the or each pivot points, wherein the continuous conveyor mechanism comprises a plurality of linkage elements each comprising at least one carrying member and a pair of one or more linkage members on opposing sides thereof for connecting the linkage elements;
wherein each linkage element is integrally formed; and
wherein, in use, the linkage elements are configured to transport bulk material received at the or each inlet to the or each outlet, and the linkage members cooperate as structural load bearing members of the continuous conveyor mechanism such that a center of mass of the bulk material is coincident with a resultant line of force of the continuous conveyor mechanism.

24. A material transport elevator for transporting bulk material, the material transport elevator comprising:
a transport means comprising at least one tail sprocket, at least one head sprocket, at least one inlet and at least one outlet, wherein the or each inlets or outlets are disposed between the sprockets;
a continuous conveyor mechanism supported by and extending between the or each sprockets, wherein the continuous conveyor mechanism comprises a plurality of linkage elements each comprising at least one carrying member and at least one linkage member connecting the linkage elements; and
wherein teeth of the tail or head sprockets are sufficiently spaced apart such that, in use, the linkage elements are configured to transport bulk material received at the inlet to be discharged from an opening of the carrying member into a guide chute disposed between the teeth of the tail or head sprockets and subsequently into the outlet, and whereby the linkage members cooperate as structural load bearing members of the continuous conveyor mechanism.
